(19) United States
(12) Patent Application Publication
(10) Pub. No.: US 2011/0191313 A1
(43) Pub. Date: Aug. 4, 2011

(54) Ranking for Informational and Unpopular Search Queries by Cumulating Click Relevance

(75) Inventors: Georges-Eric Albert Marie Robert Dupret, Mountain View, CA (US); Ciya Liao, Fremont, CA (US)

(73) Assignee: YAHOO! INC., Sunnyvale, CA (US)

(21) Appl. No.: 12/697,096

(22) Filed: Jan. 29, 2010

(51) Int. Cl. G06F 17/30

(52) U.S. Cl. 707/706; 707/770; 707/E17.014; 707/E17.032

(57) ABSTRACT

One embodiment accesses a search query and one or more sets of clicked network resources corresponding to the search query; determines a classifier model that represents the sets of clicked network resources that each satisfy the information need of one of the users and one or more subsets of the sets of clicked network resources that each do not satisfy the information need of one of the users; computes a probability value for each clicked network resource from each of the sets of clicked network resources using the classier model, wherein the probability value represents a likelihood that, after clicking on the corresponding network resource, the particular one of the users conducting the corresponding particular one of the search sessions ends the search session; and forms a set of features comprising the probability values computed for network resources from the search sessions.

### TECHNICAL FIELD

The present disclosure generally relates to improving the quality of search results generated by search engines and more specifically relates to improving the ranking of the search results generated for informational or unpopular search queries.

### BACKGROUND

The Internet provides a vast amount of information. The individual pieces of information are often referred to as “network resources” or “network content” and may have various formats, such as, for example and without limitation, texts, audios, videos, images, web pages, documents, executables, etc. The network resources are stored at many different sites, such as on computers and servers, in databases, etc., around the world. These different sites are communicatively linked to the Internet through various network infrastructures. Any person may access the publicly available network resources via a suitable network device (e.g., a computer, a smart mobile telephone, etc.) connected to the Internet.

However, due to the sheer amount of information available on the Internet, it is impractical as well as impossible for a person (e.g., a network user) to manually search throughout the Internet for specific pieces of information. Instead, most people rely on different types of computer-implemented tools to help them locate the desired network resources. One of the most commonly and widely used computer-implemented tools is a search engine, such as the search engines provided by Microsoft® Inc. (http://www.bing.com), Yahoo!® Inc. (http://search.yahoo.com), and Google™ Inc. (http://www.google.corn). To search for information relating to a specific subject matter on the Internet, a network user typically provides a short phrase or a few keywords describing the subject matter, often referred to as a “search query” or simply a “query”, to a search engine. The search engine conducts a search based on the search query using various search algorithms and generates a search result that identifies network resources that are most likely to be related to the search query. The network resources are presented to the network user, often in the form of a list of links, each link being associated with a different network document (e.g., a web page) that contains some of the identified network resources. In particular embodiments, each link is in the form of a Uniform Resource Locator (URL) that specifies where the corresponding document is located and the mechanism for retrieving it. The network user is then able to click on the URL links to view the specific network resources contained in the corresponding document as he wishes.

Sophisticated search engines implement many other functionalities in addition to merely identifying the network resources as a part of the search process. For example, a search engine usually ranks the identified network resources according to their relative degrees of relevance with respect to the search query, such that the network resources that are relatively more relevant to the search query are ranked higher and consequently are presented to the network user before the network resources that are relatively less relevant to the search query. The search engine may also provide a short summary of each of the identified network resources.

There are continuous efforts to improve the qualities of the search results generated by the search engines. Accuracy, completeness, presentation order, and speed are but a few of the performance aspects of the search engines for improvement.

### SUMMARY

The present disclosure generally relates to improving the quality of the search results generated by the search engines and more specifically relates to improving the ranking of the search results generated for informational or unpopular search queries.

Particular embodiments access a search query and one or more sets of clicked network resources corresponding to the search query, wherein, for each of the sets of clicked network resources: the set of clicked network resources comprises one or more network resources clicked by a particular one of one or more users during a particular one of one or more search sessions that is associated with the search query and conducted by the particular one of the users; the set of clicked network resources collectively satisfies an information need of the particular one of the users; and successive strict subsets of the set of clicked network resources individually does not satisfy the information need of the particular one of the users. Particular embodiments determine a classifier model that represents the sets of clicked network resources that each satisfy the information need of one of the users and one or more subsets of the sets of clicked network resources that each do not satisfy the information need of one of the users. Particular embodiments compute a probability value for each clicked network resource from each of the sets of clicked network resources using the classier model, wherein the probability value represents a likelihood that, after clicking on the corresponding network resource, the particular one of the users conducting the corresponding particular one of the search sessions ends the search session. Particular embodiments form a set of features comprising the probability values computed for network resources from the search sessions.

These and other features, aspects, and advantages of the disclosure are described in more detail below in the detailed description and in conjunction with the following figures.

### BRIEF DESCRIPTION OF THE DRAWINGS

FIG. 1 (prior art) illustrates an example search result generated for an example search query by an example search engine.

FIG. 2 illustrates an example method of generating features that may be applied to a ranking model for training the ranking model via machine learning.

FIG. 4 illustrates an example network environment.

FIG. 4 illustrates an example computer system.

### DETAILED DESCRIPTION

The present disclosure is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A search engine is a computer-implemented tool designed to search for information relevant to specific subject matters or topics on a network, such as the Internet, the World Wide Web, or an Intranet. To conduct a search, a network user may issue a search query to the search engine. The search query generally contains one or more words that describe a subject matter. In response, the search engine may identify one or more network resources that are likely to be related to the search query, which may collectively be referred to as a “search result” identified for the search query. The network resources are usually ranked and presented to the network user according to their relative degrees of relevance to the search query, or more specifically, to the subject matter described by the search query.

Sophisticated search engines implement many other functionalities in addition to merely identifying the network resources as a part of the search process. For example, a search engine usually ranks the network resources identified for a search query according to their relative degrees of relevance with respect to the search query, such that the network resources that are relatively more relevant to the search query are ranked higher and consequently are presented to the network user before the network resources that are relatively less relevant to the search query. The search engine may also provide a short summary of each of the identified network resources.

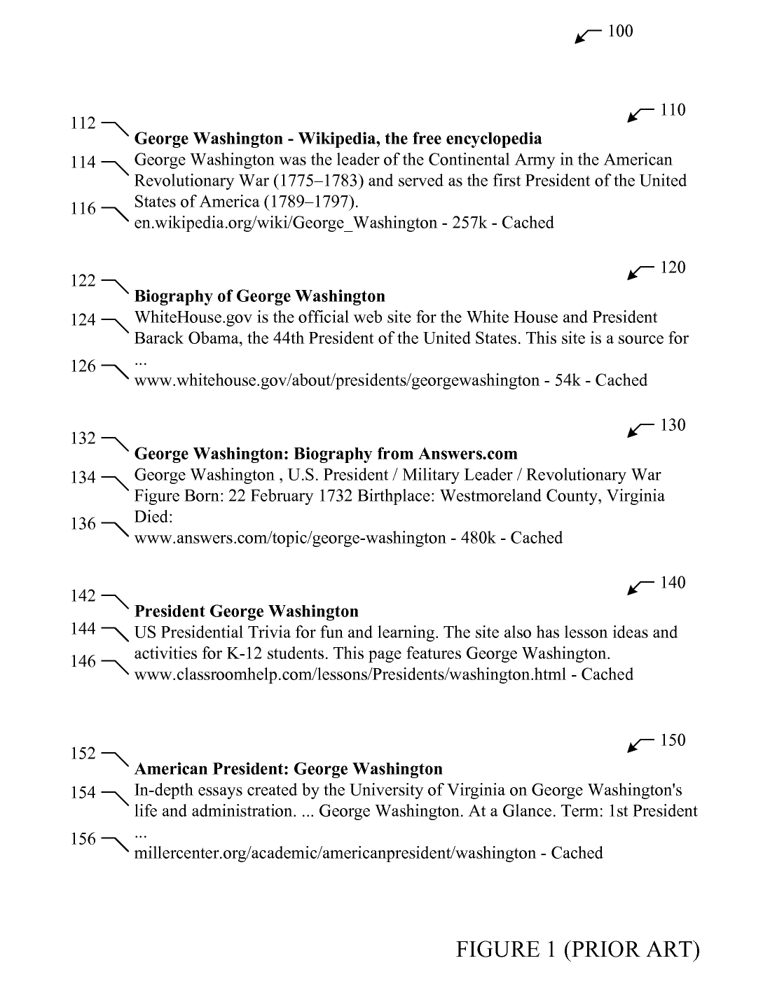

FIG. 1 illustrates an example search result 100 that identifies five network resources and more specifically, five web pages 110, 120, 130, 140, 150. Search result 100 is generated in response to an example search query “President George Washington”. Network resources 110, 120, 130, 140, 150 each include a title 112, 122, 132, 142, 152, a short summary 114, 124, 134, 144, 154 that briefly describes the respective network resource, and a clickable link 116, 126, 136, 146, 156 in the form of a URL linking to a corresponding network resource (i.e., a corresponding web page). For example, network resource 110 is a web page provided by WIKIPEDIA that contains information concerning George Washington. The URL of this particular web page is “en.wikipedia.orgNiki/George_Washington”.

In FIG. 1, network resources 110, 120, 130, 140, 150 are presented according to their relative degrees of relevance to search query “President George Washington”. That is, network resource 110 is considered somewhat more relevant to search query “President George Washington” than network resource 120, which is in turn considered somewhat more relevant than network resource 130, and so on. Consequently, network resource 110 is presented first (i.e., at the top of the ranked list constituting search result 100) followed by network resource 120, network resource 130, and so on. To view any of network resource 110, 120, 130, 140, 150, the network user requesting the search may click on the individual URLs of the specific web pages.

In particular embodiments, a search engine may implement one or more searching algorithms and a ranking model that includes one or more ranking algorithms. The searching algorithms may identify one or more network resources for each search query issued to the search engine, while the ranking model may rank the network resources identified for each search query by the searching algorithm. For example, given a search query and a set of network resources identified in response to the search query, the ranking model may rank the network resources in the set based on certain factors and features or attributes of the network resources, such as, without limitation, relevance of the network resources to the search query, the recentness or completeness of the information contained in the network resources, the popularity or user rating of the network resources, etc. In particular embodiments, as a part of the ranking process, the ranking model may determine a ranking score for each of the network resources in a set. For example, higher-ranked network resources may receive relatively higher ranking scores, and vice versa. The network resources in the set may then be ranked according to their respective ranking scores. In particular embodiments, the network resources that are ranked higher are presented before the network resources that are ranked lower to the network user requesting the search, as illustrated, for example, in FIG. 1.

In particular embodiments, a ranking model implemented by a search engine may be a feature-based mathematical model trained via machine learning. In general, machine learning is a scientific discipline that is concerned with the design and development of algorithms that allow computers to learn based on data. The computational analysis of machine learning algorithms and their performance is a branch of theoretical computer science known as computational learning theory. The desired goal is to improve the algorithms through experience (e.g., by applying the data to the algorithms in order to “train” the algorithms). The data are thus often referred to as “training data”.

One type of algorithm of machine learning is transduction, also known as transductive inference. Typically, such an algorithm may predict an output in response to an input. To train such an algorithm, for example, the training data may include training inputs and training outputs. The training outputs may be the desirable or correct outputs that should be predicted by the algorithm given the training inputs. By comparing the outputs actually predicted by the algorithm in response to the training inputs with the training outputs, the algorithm may be appropriately adjusted (i.e., improved) so that, in response to the training inputs, the algorithm predicts outputs that are the same as or similar to the training outputs. In particular embodiments, the type of training inputs and training outputs in the training data may be similar to the type of actual inputs and actual outputs to which the algorithm is to be applied.

Transduction machine learning has many applications, one of which is in the field of search engines, and more specifically, with ranking models implemented by the search engines. In particular embodiments, a ranking model may be trained with one or more sets of training data to improve the accuracy of the ranking model in terms of the ranks predicted by the ranking model for the network resources with respect to the corresponding search queries. In particular embodiments, the training data may include various types of features. The features are applied to a ranking model, and the ranking model may “learn” from these features and thus be trained.

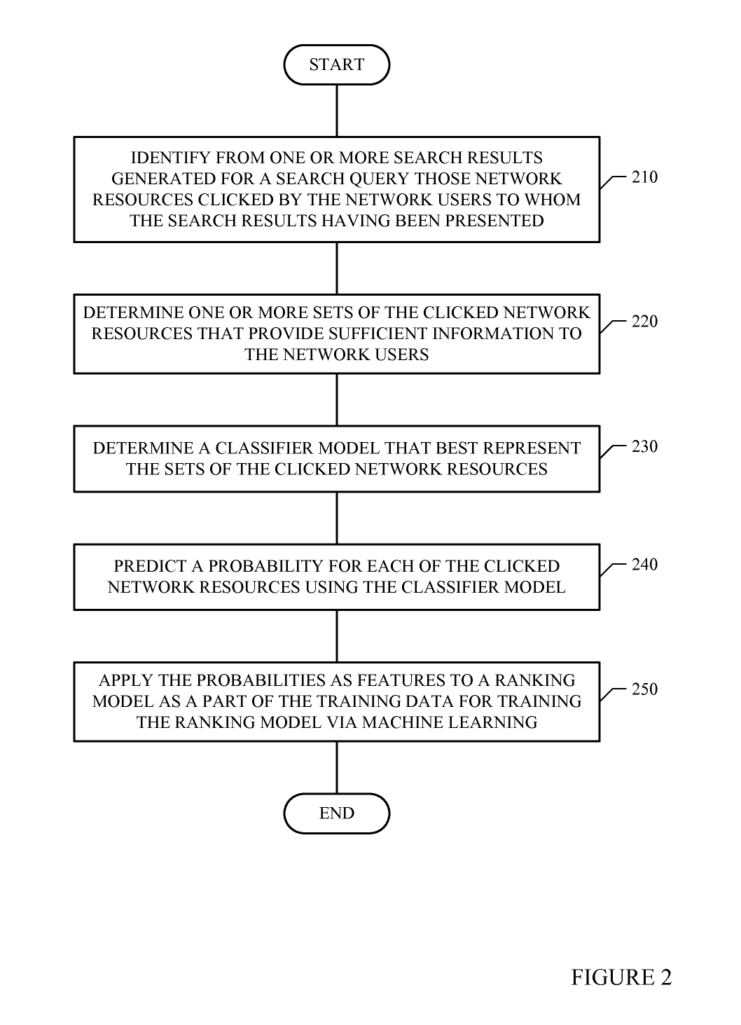

The features used to train a ranking model may be obtained or generated from various sources using various methods. FIG. 2 illustrates an example method of generating one type of features based on user clicks on specific network resources identified for the corresponding search queries. In the context of the present disclosure, this type of features may be referred to as “click-relevance features”. Click-relevance features may be applied to a ranking model either alone or together with other types of features to train the ranking model via machine learning. Note that to simplify the discussion, some of the steps of FIG. 2 are described with respect to one search query and its corresponding search results. Nevertheless, the same steps may be applied to multiple search queries and their corresponding search results.

Although in FIG. 1, example search result 100 only includes five network resources mainly for purpose of illustration, in practice, a search result may identify hundreds, thousands, or even millions of network resources. For example, for search query “President George Washington”, one search engine identifies approximately 46,000,000 network resources including web pages, images, videos, etc. These network resources are presented in a ranked list. To view any particular network resource, a network user may click on the clickable link (e.g., in the form of a unique URL) associated with the network resource. However, due to the great number of network resources often included in a search result, it is very unlikely as well as impractical for a network user to click on every link associated with every network resource presented to the user. Instead, the user may read the short summaries provided with the individual network resources and only click on a few of the network resources that appear to be particularly interesting to the user for further viewing.

Typically, a search engine dynamically generates a search result for a search query at the time the search query is received by the search engine. It is possible that multiple network users may issue the same search query to a search engine at the same or different times, as different network users may search for the same type of information. It is also possible that the same network user may issue the same search query to a search engine multiple times but at different times. Each time the search query is issued to the search engine, the search engine may generate a search result in response. However, because, from time to time, the network resources actually available may change (e.g., new network resources having been published, some old network resources having been deleted, etc.) and the status of the network resources may change (e.g., the content of some network resources having been modified, the popularity of some network resources having increased or decreased, etc.), the search results generated for the same search query by the same search engine at different times may vary. For example, between two search results generated for the same search query at two different times, a particular network resource may be included in the first search result but not in the second search result, or a particular network resource may be ranked second in the first search result but only eighth in the second search result.

Therefore, given a search query that has been issued to a search engine for multiple times, either by the same network user at different times or by different network users, multiple search results may be generated, and these search results may be different from each other (e.g., including some different network resources or some network resources being ranked differently). Consequently, each time a search result is presented to a network user who actually issued the search query to the search engine at that time, the network user may click on different network resources from the search result for further viewing.

Given a search query and one or more search results generated by a search engine in response to the search query at different times, where each search result may include one or more network resources, particular embodiments may identify those network resources included in each of the search results that have been clicked by the particular network user to whom the search result has been presented, as illustrated in step 210 of FIG. 2. From each of the search results, the actual network resources clicked by the corresponding network user may differ. In addition to the fact that the search results generated for the same search query may vary from time to time, different network users may search for different pieces of information because they have different information needs, and the same network user may have different information needs at different times.

Often, a search engine may maintain logs of the user activities performed in connection with the search engine. For example, the logs may record information such as what search queries having been received at the search engine and when, what network resources having been identified for each of the search queries and their rankings, which network resources having been clicked by the users, etc. The logs may be populated based on the data received at the search engine (e.g., search queries) or generated by the search engine (e.g., network resources identified for the search queries). For example, to determine which of the network resources having been clicked by a particular user, redirect links or script-based software agent may be used. A unique identifier or cookie may also be associated with each user, which may be recorded in the logs. Particular embodiments may process the logs maintained by the search engine to identify those network resources identified in response to a search query that have been clicked by the users issuing the search query to the search engine. In the context of the present disclosure, the network resources included in a search result that have been clicked by the network user are referred to as “clicked network resources”.

Although the network resources included in a search result are usually presented to a network user in a ranked list, the user may not necessarily click on the top-ranked network resources (e.g., the 1st-ranked, 2nd-ranked, or 3rd-ranked network resources). Sometimes, the user may move down the list and click on some lower-ranked network resources (e.g., the 10th-ranked or 20th-ranked network resources). Furthermore, the user may not necessarily click on the network resources in the order of their ranks. Sometimes, the user may first click on one network resource (e.g., the 5th-ranked network resource), then skip a few network resources and click on another network resource several places down the list (e.g., the 12th-ranked network resource), and finally move back up the list and click on a third network resource (e.g., the 3rd-ranked network resource).

Based on the actions of the network users, particular embodiments may determine one or more sets of clicked network resources that provide sufficient information to the network users with respect to a search query, as illustrated in step 220 of FIG. 2. In general, network users conduct searches using search engines for the purpose of locating specific types of information. Usually, the types of information the users search for are described by the search queries. In a common scenario, a network user, who is searching for information relating to a particular subject matter, may issue a first search query to a search engine, click and view some of the network resources presented to him in response to the first search query, reformulate and issue a second search query to the search engine, click and view some of the network resources presented to him in response to the second search query, and so on, until he has found sufficient information from the network resources he has clicked and viewed thus far, at which point he may stop his search. Therefore, particular embodiments may assume that the network users click on and presumably view the network resources until they satisfy their information needs (e.g., they have found the information they have been searching for from the network resources they have clicked and presumably viewed). Thus, based on the clicking behavior of the users, particular embodiments may attempt to predict whether the network resources included in the search results provide sufficient information to the users with respect to the subject matters described by the corresponding search queries.

In particular embodiments, a search session or simply a session may be a set of actions (e.g., issuing search queries, clicking and viewing network resources, etc.) a user undertakes to satisfy a given information need. A session may include multiple network-resource clicks and views. In particular embodiments, each session may correspond to a particular search query.

Particular embodiments may assume that a network user continues to search for network resources until he gathers enough information to satisfy his information need, at which time he stops the search. Since a network user usually clicks on a network resource in order to further view the information contained in the network resource, particular embodiments may further assume that each clicked network resource contributes a certain amount of information that the user cumulates with the information provided by the network resources that the user has clicked previously. Thus, particular embodiments may assume that a network user continues to click on network resources until he has gathered enough information, at which point the user stops clicking on the network resources. Consequently, particular embodiments may assume that a session ending with a click on a network resource is a successful session where the user has found sufficient information to satisfy his need for conducting the search. Particular embodiments may ignore the possibility that a network user may abandon a search before he has found sufficient information due to, for example, a lack of time or an inability to find the relevant information.

Hereafter, let qᵢ denote a particular search query and rᵢ denote a particular network resource. Note that the index of the network resource rᵢ is not its rank within any particular search result. In particular embodiments, each publicly available network resource may be identified by a unique identifier, such as, for example and without limitation, its unique URL. Thus, each network resource may be identified with a unique index.

Particular embodiments may assume that each clicked network resource, hereafter denoted by rᵢ^{c}, may provide some utility (e.g., information), hereafter denoted by uᵢ, to a network user who has clicked it. Particular embodiments may hypothesize that the utilities are additive. Thus, if the user has clicked on three network resources, r₁^{c}, r₂^{c}, and r₃^{c}, then the total amount of utility provided by these three network resources is u₁+u₂+u₃. The assumption that the utilities may be simply added is likely an approximation. More realistically, the total amount of utility of a set of clicked network resources is probably lower than the sum of the individual network-resource utilities because some clicked network resources may partially or fully repeat the same information.

Consider an example search scenario. A network user issues a search query, q₁, to a search engine and is presented with a search result corresponding to q₁ from which he clicks on three network resources, r₄^{c}, r₁₂^{c}, and r₂^{c}, (again, the indices of the clicked network resources are not their ranks within the search result but are their unique identifiers). The user then reformulates and issues another search query, q₂, to the search engine. From the search result corresponding to q₂, the user clicks on one network resource, r₁₆^{c}. The user again reformulates and issues a final search query, q₃, to the search engine. From the search result corresponding to q₂, the user clicks on two network resource, r₂₀^{c} and r₈^{c}. Thus, for this example search, the actions of the user includes: (1) issuing q₁; (2) clicking on r₄^{c}; (3) clicking on r₁₂^{c}; (4) clicking on r₂^{c}; (5) issuing q₂; (6) clicking on r₁₆^{c}; (7) issuing q₃; (8) clicking on r₂₀^{c}; and (9) clicking on r₈^{c}.

Because the utilities provided by the clicked network resources are additive, particular embodiments may assume that, after clicking on r₄^{c}, the user acquires a quantity of u₄ utility from r₄^{c}; after clicking on r₁₂^{c}, the user cumulatively acquires a quantity of u₄+u₁₂ utility from r₄^{c} and r₁₂^{c}; after clicking on r₂^{c}, the user cumulatively acquires a quantity of u₄+u₁₂+u₂ utility from r₄^{c}, r₁₂^{c}, r₂^{c}; and so on. At the end of the search, the user has acquired a total quantity of u₄+u₁₂+u₂+u₁₆+u₂₀+u₈ utility from the six clicked network resources.

Analyzing the user's actions, after clicking on r₄^{c}, the user next clicks on r₁₂^{c}. The fact that the user continues his search after clicking on and presumably viewing r₄^{c} suggests that r₄^{c} alone does not provide enough utility to satisfy the user's information need, which has resulted in the user clicking on and presumably viewing r₁₂^{c}. Similarly, after clicking on r₁₂^{c}, the user next clicks on r₂^{c} which suggests that r₄^{c} and r₁₂^{c} together still do not provide enough utility to satisfy the user's information need. It is not until the user has clicked on six network resources before he stops the search, which suggests that r₄^{c}, r₁₂^{c}, r₂^{c}, r₁₆^{c}, r₂₀^{c}, and r₈^{c} collectively satisfy the user's information need.

Particular embodiments may consider the above example search scenario as from three search sessions, corresponding to q₁, q₂, and q₃. For the first session corresponding to q₁, six clicked network resources, r₄^{c}, r₁₂^{c}, r₂^{c}, r₁₆^{c}, r₂₀^{c}, and r₈^{c}, together satisfy the user's information need because the user has clicked on these six network resources after issuing q₁ to the search engine. This also suggests that, for example, r₄^{c} and r₁₂^{c} (clicked in that order) alone does not satisfy the user's information need with respect to q₁. Similarly, r₄^{c}, r₁₂^{c}, and r₂^{c} (clicked in that order) alone or r₄^{c}, r₁₂^{c}, r₂^{c}, and r₁₆^{c}, (clicked in that order) alone or r₄^{c}, r₁₂^{c}, r₂^{c}, r₁₆^{c}, and r₂₀^{c}, (clicked in that order) alone do not satisfy the user's information need with respect to q₁. For the second session corresponding to q₂, three network resources, r₁₆^{c}, r₂₀^{c}, and r₈^{c}, together satisfy the user's information need because the user has clicked on these three network resources after issuing q₂ to the search engine. This also suggests that, for example, r₁₆^{c} and r₂₀^{c} (clicked in that order) alone does not satisfy the user's information need with respect to q₂. For the third session corresponding to q₃, two network resources, r₂₀₆^{c} and r₈^{c}, together satisfy the user's information need because the user has clicked on these two network resources after issuing q₃ to the search engine. This also suggests that, for example, r₂₀^{c} alone does not satisfy the user's information need with respect to q₃.

From the actions performed by the users in connection with a search engine, such as the search queries issued to the search engine and the network resources clicked on by the users, particular embodiments may extract various search sessions. Since a particular search query may be issued to a search engine multiple times, there may be multiple sessions corresponding to the same search query.

Consider an example search query and four example sessions corresponding to the example search query. Suppose during the first example session, a first user has clicked on three network resources, r₃^{c} followed by r₅^{c} followed by r₁₃^{c}, and acquired an amount of u₃+u₅+u₁₃ utility before stopping his search. This suggests that for the first user, r₃^{c}, r₅^{c}, and r₁₃^{c} together satisfy his information need, but r₃^{c} alone or only r₃^{c} and r₅^{c} together do not satisfy his information need.

The sequence of the user clicking actions in the first example session may be summarized in the following TABLE 1. The first column of TABLE 1 represents the network resources in the order that they have been clicked. The second column is the amount of utility the user has gathered after each click on the network resource. The third column indicates whether the click is the last action of the session (i.e., whether the user stops his search after that click). The number 0 represents FALSE (i.e., the search has not stopped), and the number 1 represents TRUE (i.e., the search has stopped). The fourth and last column reports the probability of the event reported in the previous columns, with u₀ representing an intercept.

TABLE 1

| Clicked | | | |
|---|---|---|---|
| Network | | Search | |
| Resources | Utility Amount | Stopped | Event Probability |
| r₃^{c} | u₃ | 0 | 1 − σ(u₀ + u₃) |
| r₅^{c} | u₃ + u₅ | 0 | 1 − σ(u₀ + u₃ + u₅) |
| r₁₃^{c} | u₃ + u₅ + u₁₃ | 1 | σ(u₀ + u₃ + u₅ + u₁₃) |

Suppose during the second example session, a second user has clicked on two network resources, r₁^{c} followed by r₇^{c}, and acquired an amount of u₁+u₇ utility before stopping her search. The second user clicks on different network resources from those clicked by the first user because, for example, the two users may have different information needs despite the fact that they both have issued the same search query to the search engine. The second user's actions suggest that r₁^{c} and r₇^{c} together provide sufficient amount of information, u₁+u₇, to satisfy her information need, but either r₁^{c} or r₇^{c} alone do not.

Sometimes, a single network resource may satisfy a user's information need. Suppose during the third example session, a third user has only clicked on one network resource, r₂^{c}, before stopping her search. The third user thus has acquired an amount of u₂ utility from the third example session. The fact that the third user has stopped her search after clicking on r₂^{c} suggests that r₂^{c} alone is sufficient to satisfy her information need.

Suppose during the fourth example session, the second user again has issued the search query to the search engine, but this time, her information need is somewhat different from that of the previous occasion (i.e., during the second session). As a result, the second user has clicked on three network resources, r₂^{c} followed by r₅^{c} followed by r₉^{c}, and acquired an amount of u₂+u₅+u₉ utility before stopping her search. Similarly as before, this suggests that r₂^{c}, r₅^{c}, and r₉^{c} together satisfy the second user's information need, but r₂^{c} alone or only r₂^{c} and r₅^{c} together do not satisfy her information need. Note that although for the third user of the third example session, r₂^{c} alone satisfies the third user's information need, for the second user of the fourth example session, r₂^{c} alone does not satisfy the second user's information need, because different users may have different information needs, different levels of knowledge, or are more or less impatient, and so on.

Sometimes, a user may click several times on the same network resource. If the time between two clicks is small, and if no other network resource has been clicked in between, then this may suggest either that the user is used to double-clicking, or that the network latency is large. In this case, particular embodiments may ignore the repeated clicks and treat them as a single click. On the other hand, if the time lapse between two clicks on the same network resource's link is large or the user has clicked other network resource in between, this may suggest that the user has come to the conclusion that the network resource he has visited multiple times in the same session is probably one of the best documents he can get. Nevertheless, particular embodiments may choose to ignore the sessions with multiple clicks on the same network resource to simplify the analysis.

However, a more careful analysis may reveal that this type of sessions may be particularly informative. Therefore, alternatively, particular embodiments may also include the repeated clicks as follows. As an example, suppose the user has clicked on r₁^{c}, and then r₂^{c}, and then r₁^{c} again. In this case, r₁^{c} has been clicked twice by the user (i.e., r₁^{c} has received multiple clicks in the same session). This suggests that, first, r₁^{c} alone does not satisfy the user's information need; and second, as for r₁^{c} and r₂^{c} together, they do not satisfy the user's information need one time but do satisfy the user's information need another time (i.e., satisfy once and not satisfy once). The event probabilities for the two cases may be calculated as: (1) 1−σ(u₀+u₁) for r₁^{c} alone; and (2) (1−σ(u₀+u₁+u₂))σ(u₀+u₁+u₂) for r₁^{c} and r₂^{c} together. Therefore, the total event probability equals (1−94 (u₀+u₁))(1−σ(u₀+u₁+u₂))σ(u₀+u₁+u₂).

Consider the above example search query having three corresponding example sessions. To summarize: (1) during the first example session, the first user has clicked on network resources r₃^{c}, r₅^{c}, and r₁₃^{c} by the time his information need is satisfied (i.e., before he stops clicking on any network resources); (2) during the second example session, the second user has clicked on network resources r₁^{c} and r₇^{c} the time her information need is satisfied; (3) during the third example session, the third user has clicked on network resource r₂^{c} by the time her information need is satisfied; and (4) during the fourth example session, the second user has clicked on network resources r₂^{c}, r₅^{c}, and r₉^{c} by the time her information need is satisfied. The following TABLE 2A summarizes the clicked network resources of the four example sessions with respect to the example search query.

TABLE 2A

| Clicked Network Resources | Utility |
|---|---|
| r₃^{c}, r₅^{c}, r₁₃^{c} | u₃ + u₅ + u₁₃ |
| r₁^{c}, r₇^{c} | u₁ + u₇ |
| r₂^{c} | u₂ |
| r₂^{c}, r₅^{c}, r₉^{c} | u₂ + u₅ + u₉ |

As indicated above, particular embodiments may assume that for each session, the last click on a network resource suggests that the user has obtained sufficient information from the combination of all the network resources clicked during the session. If, for each of the network resources, the number 1 represents that the network resource has been clicked during a session and the number 0 represents that the network resources has not been clicked during a session, and for each user's information need, the number 1 represents that the user's information need has been satisfied (i.e., the user has gathered sufficient information from the clicked network resources) and the number 0 represents that the user's information need has not been satisfied, then the clicking actions of the above four example sessions may be illustrated in the following TABLE 2B. Rows 2-4 of TABLE 2B correspond to the first example session. Rows 5-6 correspond to the second example session. Row 7 corresponds to the third example session. Rows 8-10 correspond to the fourth example session. For example, during the first example session, row 2 indicates that only r₃^{c} has been clicked, which is insufficient to satisfy the first user's information need; row 3 indicates that both r₃^{c} and r₅^{c} have been clicked, but is still insufficient; and row 4 indicates r₃^{c}, r₅^{c}, and r₁₃^{c} have all been clicked, which is sufficient to satisfy the first user's information need.

TABLE 2B

| U₀ | U₁ | U₂ | U₃ | . . . | U₅ | . . . | U₇ | . . . | U₉ | . . . | U₁₃ | . . . | satisfied |
|---|---|---|---|---|---|---|---|---|---|---|---|---|---|
| 1 | 0 | 0 | 1 | . . . | 0 | . . . | 0 | . . . | 0 | . . . | 0 | . . . | 0 |
| 1 | 0 | 0 | 1 | . . . | 1 | . . . | 0 | . . . | 0 | . . . | 0 | . . . | 0 |
| 1 | 0 | 0 | 1 | . . . | 1 | . . . | 0 | . . . | 0 | | 1 | . . . | 1 |
| 1 | 1 | 0 | 0 | . . . | 0 | . . . | 0 | . . . | 0 | . . . | 0 | . . . | 0 |
| 1 | 1 | 0 | 0 | . . . | 0 | . . . | 1 | . . . | 0 | . . . | 0 | . . . | 1 |
| 1 | 0 | 1 | 0 | . . . | 0 | . . . | 0 | . . . | 0 | . . . | 0 | . . . | 1 |
| 1 | 0 | 1 | 0 | . . . | 0 | . . . | 0 | . . . | 0 | . . . | 0 | . . . | 0 |
| 1 | 0 | 1 | 0 | . . . | 1 | . . . | 0 | . . . | 0 | . . . | 0 | . . . | 0 |
| 1 | 0 | 1 | 0 | . . . | 1 | . . . | 0 | . . . | 1 | . . . | 0 | . . . | 1 |

Particular embodiments may determine a classifier model for a search query that best represents the clicking actions of all the sessions corresponding to the search query and whether each combination of the clicked network resources provide sufficient utility (e.g., information) that satisfies a user's information need during each of the sessions, as illustrated in step 230 of FIG. 2. In particular embodiments, the classifier model may attempt to balance all the clicking situations from all the sessions corresponding to the search query. In particular embodiments, the variable the classifier model attempts to predict is whether, given a certain amount of utility (e.g., based on a combination of clicked network resources), the user will stop or continue his search. In particular embodiments, the variable may be represented as a probability between 0 and 1, with 0 representing the user continues his search (i.e., the user's information need has not been satisfied) and 1 representing the user stops his search (i.e., the user's information has been satisfied).

In particular embodiments, the classifier model may be a logistic regression model. To find a logistic repression model that best represent the sessions corresponding to a particular search query, particular embodiments may apply the click actions of the sessions (e.g., as illustrated in TABLE 2B) to the logistic regression model to train the logistic regression model. The effect of training a logistic regression model using the clicking actions and the results of the sessions may be to obtain the logistic regression model that best represents the clicking actions and the results of these sessions.

As indicated above, particular embodiments may assume that the utilities provided by the individual network resources are additive. Let C represent a set of clicked network resources. Note that C may include a single clicked network resource or multiple clicked network resources. Let U(C) represent the amount of utility the user gathers from C, which may be the sum of the utilities of the individual clicked network resources in C. U(C) may be a value between negative infinity and infinity. Particular embodiments may assume that the probably that the user stops his search after gathering U(C) (i.e., after clicking on the network resources of C) depend only or mainly on U(C). This in turn suggests the use of a logistic function to map U(C) to a probability of the user stopping his search as:

$$\begin{matrix}P ( s = 1 \vert U ( C ) ) = σ ( U ( C ) ) \\ = σ ( {u}_{0} + {\sum }_{r ∈ C} {u}_{r} ) \\ = {( 1 + exp ( - {u}_{0} - {\sum }_{r ∈ C} {u}_{r} ) )}^{- 1} ;\end{matrix}$$

where: (1) S represents the variable predicted by the classifier model; (2) σ( ) is the logistic function, which may be defined as

$$σ ( x ) = \frac{1}{1 + {e}^{- x}} ; U ( C ) = {\sum }_{r ∈ C} {u}_{r} \qquad ( 3 )$$

is the sum of the utilities of the clicked network resources in C; and (4) u₀ is an intercept. Particular embodiments may choose u₀ to be query dependent. If U(C)=u₀, then the user will stop his search with probability

$$P ( s = 1 \vert U ( C ) ) = \frac{1}{2} .$$

Particular embodiments may consider the join likelihood of a session as the product of the likelihood of the events belonging to that session because, given the sets of clicked network resources, the probabilities of the users stopping the searches are independent. Thus, for the first example session, the join likelihood may be calculated as:

Lₛ₁=P(s=0|r₃^{c})P(s=0|r₃^{c}, r₅^{c})P(s=1|r₃^{c}, r₅^{c}, r₁₃^{c})=(1−(1+e^{-(u}^{₀}^{+u}^{₃}⁾)⁻¹)×(1−(1+e^{(u}^{₀}^{+u}^{₃}^{+u}^{₅}⁾)⁻¹)×(1+e^{-(u}^{₀}^{+u}^{₃}^{+u}^{₅}^{+u}^{₁₃}⁾)⁻¹

For the second example session, the join likelihood may be calculated as:

Lₛ₂=P(s=0|r₁^{c})P(s=1|r₁^{c}, r₇^{c})=(1−(1+e^{-(u}^{₀}^{+u}^{₁}⁾)⁻¹)×(1+e^{(u}^{₀}^{+u}^{₁}^{+u}^{₇}⁾)⁻¹.

For the third example session, the likelihood may be calculated as:

Lₛ₃=P(s=1|r₂^{c})=(1+e^{-(u}^{₀}^{+u}^{₂}⁾)⁻¹.

For the fourth example session, the likelihood may be calculated as:

Lₛ₄=P(s=0|r₂^{c})P(s=0|r₂^{c}, r₅^{c})P(s=1|r₂^{c}, r₅^{c}, r₉^{c})=(1−(1+e^{-(u}^{₀}^{+u}^{₂}⁾)⁻¹)×(1−(1+e^{(u}^{₀}^{+u}^{₂}^{+u}^{₅}⁾)⁻¹)×(1+e^{-(u}^{₀}^{+u}^{₂}^{+u}^{₅}^{+u}^{₉}⁾)⁻¹

Particular embodiments may consider the join likelihood of all the sessions corresponding to a search query as the product of the likelihood of all the individual sessions. Thus, for the example search query having four example session, the join likelihood of the search query is the product of the four likelihoods of the four example sessions (i.e., L_{q}=Lₛ₁×Lₛ₂×Lₛ₃×Lₛ₄)

Particular embodiments may maximize the join likelihood of a search query with respect to the utilities and the intercept. However, because the search logs may be sparse and noisy, particular embodiments may introduce a prior on the network-resource utilities and compute the “Maximum a Posteriori” (MA) instead of the maximum likelihood estimate.

Once a classifier model has been determined for a search query, for each of the clicked network resources corresponding to the search query, particular embodiments may predict a probability value between 0 and 1 using the classifier model, which represents the probability that a user will stop his search after clicking on that network resource, as illustrated in step 240 of FIG. 2. Thus, for the first example session, there are three clicked network resources, r₃^{c}, r₅^{c}, and r₁₃^{c}. The classifier model may calculate a probability value between 0 and 1 for each of r₃^{c}, r₅^{c}, and r₁₃^{c}. For the second example session, there are two clicked network resources, r₁^{c} and r₇^{c}. The classifier model may calculate a probability value between 0 and 1 for each of r₁^{c} and r₇^{c}. And so on.

Furthermore, there may be multiple search queries, and each search query may result in multiple search sessions, during which the users click on some of the network resources presented to them. A classifier model may be determined for each of the search queries and their corresponding set of clicked network resources, and then for each of the clicked network resources corresponding to each of the search queries, a probability value may be determined using the corresponding classier model determined for that search query. These probability values may be combined together as a set of features. The features may be applied to a ranking model, optionally with other types of features, to train the ranking model via machine learning, as illustrated in step 250 of FIG. 2.

Particular embodiments may be implemented in a network environment. FIG. 3 illustrates an example network environment 300. Network environment 300 includes a network 310 coupling one or more servers 320 and one or more clients 330 to each other. In particular embodiments, network 310 is an intranet, an extranet, a virtual private network (VPN), a local area network (LAN), a wireless LAN (WLAN), a wide area network (WAN), a metropolitan area network (MAN), a communications network, a satellite network, a portion of the Internet, or another network 310 or a combination of two or more such networks 310. The present disclosure contemplates any suitable network 310.

One or more links 350 couple servers 320 or clients 330 to network 310. In particular embodiments, one or more links 350 each includes one or more wired, wireless, or optical links 350. In particular embodiments, one or more links 350 each includes an intranet, an extranet, a VPN, a LAN, a WLAN, a WAN, a MAN, a communications network, a satellite network, a portion of the Internet, or another link 350 or a combination of two or more such links 350. The present disclosure contemplates any suitable links 350 coupling servers 320 and clients 330 to network 310.

In particular embodiments, each server 320 may be a unitary server or may be a distributed server spanning multiple computers or multiple datacenters. Servers 320 may be of various types, such as, for example and without limitation, web server, news server, mail server, message server, advertising server, file server, application server, exchange server, database server, or proxy server. In particular embodiments, each server 320 may include hardware, software, or embedded logic components or a combination of two or more such components for carrying out the appropriate functionalities implemented or supported by server 320. For example, a web server is generally capable of hosting websites containing web pages or particular elements of web pages. More specifically, a web server may host HTML files or other file types, or may dynamically create or constitute files upon a request, and communicate them to clients 330 in response to HTTP or other requests from clients 330. A mail server is generally capable of providing electronic mail services to various clients 330. A database server is generally capable of providing an interface for managing data stored in one or more data stores.

In particular embodiments, each client 330 may be an electronic device including hardware, software, or embedded logic components or a combination of two or more such components and capable of carrying out the appropriate functionalities implemented or supported by client 330. For example and without limitation, a client 330 may be a desktop computer system, a notebook computer system, a netbook computer system, a handheld electronic device, or a mobile telephone. A client 330 may enable an network user at client 330 to access network 310. A client 330 may have a web browser, such as Microsoft Internet Explorer or Mozilla Firefox, and may have one or more add-ons, plug-ins, or other extensions, such as Google Toolbar or Yahoo Toolbar. A client 330 may enable its user to communicate with other users at other clients 330. The present disclosure contemplates any suitable clients 330.

In particular embodiments, one or more data storages 340 may be communicatively linked to one or more severs 320 via one or more links 350. In particular embodiments, data storages 340 may be used to store various types of information. In particular embodiments, the information stored in data storages 340 may be organized according to specific data structures. Particular embodiments may provide interfaces that enable servers 320 or clients 330 to manage (e.g., retrieve, modify, add, or delete) the information stored in data storage 340.

In particular embodiments, a server 320 may include a search engine 322. Search engine 322 may include hardware, software, or embedded logic components or a combination of two or more such components for carrying out the appropriate functionalities implemented or supported by search engine 322. For example and without limitation, search engine 322 may implement one or more search algorithms that may be used to identify network resources in response to the search queries received at search engine 322, one or more ranking algorithms that may be used to rank the identified network resources, one or more summarization algorithms that may be used to summarize the identified network resources, and so on. The ranking algorithms implemented by search engine 322 may be trained using the set of features generated using the method illustrated in FIG. 2 together with other types of features generated using other methods.

Particular embodiments may be implemented as hardware, software, or a combination of hardware and software. For example and without limitation, one or more computer systems may execute particular logic or software to perform one or more steps of one or more processes described or illustrated herein. One or more of the computer systems may be unitary or distributed, spanning multiple computer systems or multiple datacenters, where appropriate. The present disclosure contemplates any suitable computer system. In particular embodiments, performing one or more steps of one or more processes described or illustrated herein need not necessarily be limited to one or more particular geographic locations and need not necessarily have temporal limitations. As an example and not by way of limitation, one or more computer systems may carry out their functions in “real time,” “offline,” in “batch mode,” otherwise, or in a suitable combination of the foregoing, where appropriate. One or more of the computer systems may carry out one or more portions of their functions at different times, at different locations, using different processing, where appropriate. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more computer-readable storage media may store or otherwise embody software implementing particular embodiments. A computer-readable medium may be any medium capable of carrying, communicating, containing, holding, maintaining, propagating, retaining, storing, transmitting, transporting, or otherwise embodying software, where appropriate. A computer-readable medium may be a biological, chemical, electronic, electromagnetic, infrared, magnetic, optical, quantum, or other suitable medium or a combination of two or more such media, where appropriate. A computer-readable medium may include one or more nanometer-scale components or otherwise embody nanometer-scale design or fabrication. Example computer-readable storage media include, but are not limited to, compact discs (CDs), field-programmable gate arrays (FPGAs), floppy disks, floptical disks, hard disks, holographic storage devices, integrated circuits (ICs) (such as application-specific integrated circuits (ASICs)), magnetic tape, caches, programmable logic devices (PLDs), random-access memory (RAM) devices, read-only memory (ROM) devices, semiconductor memory devices, and other suitable computer-readable storage media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

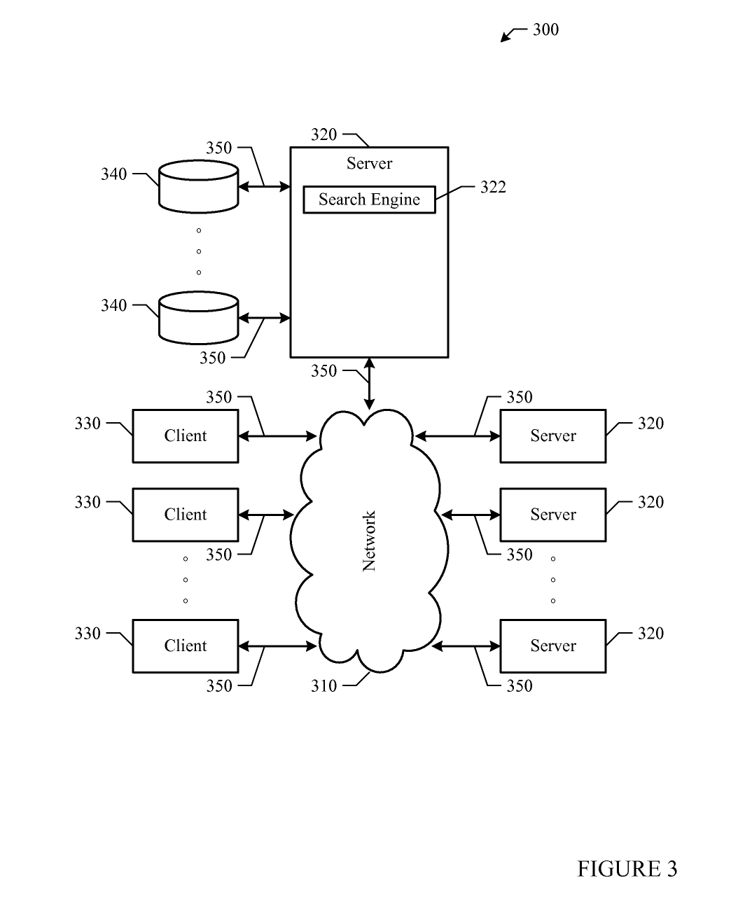

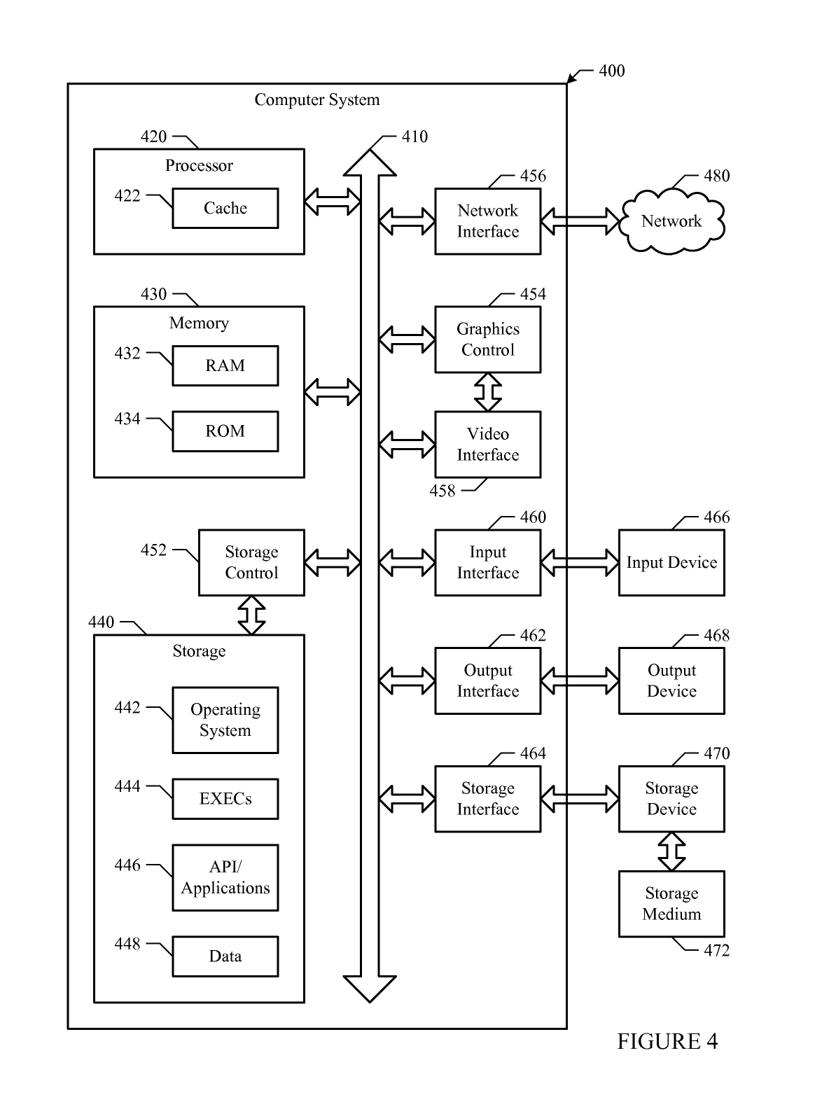

For example, FIG. 4 illustrates an example computer system 400 suitable for implementing one or more portions of particular embodiments. Although the present disclosure describes and illustrates a particular computer system 400 having particular components in a particular configuration, the present disclosure contemplates any suitable computer system having any suitable components in any suitable configuration. Moreover, computer system 400 may have take any suitable physical form, such as for example one or more integrated circuit (ICs), one or more printed circuit boards (PCBs), one or more handheld or other devices (such as mobile telephones or PDAs), one or more personal computers, or one or more super computers.

System bus 410 couples subsystems of computer system 400 to each other. Herein, reference to a bus encompasses one or more digital signal lines serving a common function. The present disclosure contemplates any suitable system bus 410 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 400 includes one or more processors 420 (or central processing units (CPUs)). A processor 420 may contain a cache 422 for temporary local storage of instructions, data, or computer addresses. Processors 420 are coupled to one or more storage devices, including memory 430. Memory 430 may include random access memory (RAM) 432 and read-only memory (ROM) 434. Data and instructions may transfer bidirectionally between processors 420 and RAM 432. Data and instructions may transfer unidirectionally to processors 420 from ROM 434. RAM 432 and ROM 434 may include any suitable computer-readable storage media.

Computer system 400 includes fixed storage 440 coupled bi-directionally to processors 420. Fixed storage 440 may be coupled to processors 420 via storage control unit 452. Fixed storage 440 may provide additional data storage capacity and may include any suitable computer-readable storage media. Fixed storage 440 may store an operating system (OS) 442, one or more executables 444, one or more applications or programs 446, data 448, and the like. Fixed storage 440 is typically a secondary storage medium (such as a hard disk) that is slower than primary storage. In appropriate cases, the information stored by fixed storage 440 may be incorporated as virtual memory into memory 430.

Processors 420 may be coupled to a variety of interfaces, such as, for example, graphics control 454, video interface 458, input interface 460, output interface 462, and storage interface 464, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems. Network interface 456 may couple processors 420 to another computer system or to network 480. With network interface 456, processors 420 may receive or send information from or to network 480 in the course of performing steps of particular embodiments. Particular embodiments may execute solely on processors 420. Particular embodiments may execute on processors 420 and on one or more remote processors operating together.

In a network environment, where computer system 400 is connected to network 480, computer system 400 may communicate with other devices connected to network 480. Computer system 400 may communicate with network 480 via network interface 456. For example, computer system 400 may receive information (such as a request or a response from another device) from network 480 in the form of one or more incoming packets at network interface 456 and memory 430 may store the incoming packets for subsequent processing. Computer system 400 may send information (such as a request or a response to another device) to network 480 in the form of one or more outgoing packets from network interface 456, which memory 430 may store prior to being sent. Processors 420 may access an incoming or outgoing packet in memory 430 to process it, according to particular needs.

Computer system 400 may have one or more input devices 466 (which may include a keypad, keyboard, mouse, stylus, etc.), one or more output devices 468 (which may include one or more displays, one or more speakers, one or more printers, etc.), one or more storage devices 470, and one or more storage medium 472. An input device 466 may be external or internal to computer system 400. An output device 468 may be external or internal to computer system 400. A storage device 470 may be external or internal to computer system 400. A storage medium 472 may be external or internal to computer system 400.

Particular embodiments involve one or more computer-storage products that include one or more computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, floptical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

As an example and not by way of limitation, memory 430 may include one or more computer-readable storage media embodying software and computer system 400 may provide particular functionality described or illustrated herein as a result of processors 420 executing the software. Memory 430 may store and processors 420 may execute the software. Memory 430 may read the software from the computer-readable storage media in mass storage device 430 embodying the software or from one or more other sources via network interface 456. When executing the software, processors 420 may perform one or more steps of one or more processes described or illustrated herein, which may include defining one or more data structures for storage in memory 430 and modifying one or more of the data structures as directed by one or more portions the software, according to particular needs. In addition or as an alternative, computer system 400 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising, by one or more computer systems:
accessing a search query and one or more sets of clicked network resources corresponding to the search query, wherein, for each of the sets of clicked network resources:
the set of clicked network resources comprises one or more network resources clicked by a particular one of one or more users during a particular one of one or more search sessions that is associated with the search query and conducted by the particular one of the users;
the set of clicked network resources collectively satisfies an information need of the particular one of the users; and
successive strict subsets of the set of clicked network resources individually does not satisfy the information need of the particular one of the users;
determining a classifier model that represents the sets of clicked network resources that each satisfy the information need of one of the users and one or more subsets of the sets of clicked network resources that each do not satisfy the information need of one of the users;
computing a probability value for each clicked network resource from each of the sets of clicked network resources using the classier model, wherein the probability value represents a likelihood that, after clicking on the corresponding network resource, the particular one of the users conducting the corresponding particular one of the search sessions ends the search session; and
forming a set of features comprising the probability values computed for network resources from the search sessions.

2. The method recited in claim 1, wherein:
each of the search sessions comprises one or more actions performed by the particular one of the users conducting the search session, wherein the actions comprise issuing the search query to the search engine, and clicking on one or more of the network resources identified by the search engine for the search query; and
each of the search sessions ends with the particular one of the users conducting the search session clicking on one of the network resources.

3. The method recited in claim 1, wherein, for each of the sets of clicked network resources associated with the particular one of the search sessions:
each network resource from the set of network resources provides a particular amount of utility to the particular one of the users conducting the particular one of the search sessions;
a total amount of utility provided by the set of clicked network resources is approximately the sum of the particular amounts of utility of the individual clicked network resources in the set; and
the total amount of utility satisfies the information need of the particular of the users conducting the particular one of the search sessions.

4. The method recited in claim 1, wherein the classifier model is a logistic regression model.

5. The method recited in claim 4, wherein determining the classifier model comprises applying the sets of clicked network resources and the successive subsets of clicked network resources to the logistic regression model to train the logistic regression model.

6. The method recited in claim 1, further comprising applying the set of features to a ranking model to train the ranking model via machine learning.

7. A system comprising:
a memory comprising instructions executable by one or more processors; and
one or more processors coupled to the memory and operable to execute the instructions, the one or more processors being operable when executing the instructions to:
access a search query and one or more sets of clicked network resources corresponding to the search query, wherein, for each of the sets of clicked network resources:
the set of clicked network resources comprises one or more network resources clicked by a particular one of one or more users during a particular one of one or more search sessions that is associated with the search query and conducted by the particular one of the users;
the set of clicked network resources collectively satisfies an information need of the particular one of the users; and
successive strict subsets of the set of clicked network resources individually does not satisfy the information need of the particular one of the users;
determine a classifier model that represents the sets of clicked network resources that each satisfy the information need of one of the users and one or more subsets of the sets of clicked network resources that each do not satisfy the information need of one of the users;
compute a probability value for each clicked network resource from each of the sets of clicked network resources using the classier model, wherein the probability value represents a likelihood that, after clicking on the corresponding network resource, the particular one of the users conducting the corresponding particular one of the search sessions ends the search session; and
form a set of features comprising the probability values computed for network resources from the search sessions.

8. The system recited in claim 7, wherein:
each of the search sessions comprises one or more actions performed by the particular one of the users conducting the search session, wherein the actions comprise issuing the search query to the search engine, and clicking on one or more of the network resources identified by the search engine for the search query; and
each of the search sessions ends with the particular one of the users conducting the search session clicking on one of the network resources.

9. The system recited in claim 7, wherein, for each of the sets of clicked network resources associated with the particular one of the search sessions:
each network resource from the set of network resources provides a particular amount of utility to the particular one of the users conducting the particular one of the search sessions;
a total amount of utility provided by the set of clicked network resources is approximately the sum of the particular amounts of utility of the individual clicked network resources in the set; and
the total amount of utility satisfies the information need of the particular of the users conducting the particular one of the search sessions.

10. The system recited in claim 7, wherein the classifier model is a logistic regression model.

11. The system recited in claim 10, wherein to determine the classifier model comprises apply the sets of clicked network resources and the successive subsets of clicked network resources to the logistic regression model to train the logistic regression model.

12. The system recited in claim 7, wherein the one or more processors are further operable when executing the instructions to apply the set of features to a ranking model to train the ranking model via machine learning.

13. One or more computer-readable tangible storage media embodying software operable when executed by one or more computer systems to:
access a search query and one or more sets of clicked network resources corresponding to the search query, wherein, for each of the sets of clicked network resources:
the set of clicked network resources comprises one or more network resources clicked by a particular one of one or more users during a particular one of one or more search sessions that is associated with the search query and conducted by the particular one of the users;
the set of clicked network resources collectively satisfies an information need of the particular one of the users; and
successive strict subsets of the set of clicked network resources individually does not satisfy the information need of the particular one of the users;
determine a classifier model that represents the sets of clicked network resources that each satisfy the information need of one of the users and one or more subsets of the sets of clicked network resources that each do not satisfy the information need of one of the users;
compute a probability value for each clicked network resource from each of the sets of clicked network resources using the classier model, wherein the probability value represents a likelihood that, after clicking on the corresponding network resource, the particular one of the users conducting the corresponding particular one of the search sessions ends the search session; and
form a set of features comprising the probability values computed for network resources from the search sessions.

14. The media recited in claim 13, wherein:
each of the search sessions comprises one or more actions performed by the particular one of the users conducting the search session, wherein the actions comprise issuing the search query to the search engine, and clicking on one or more of the network resources identified by the search engine for the search query; and
each of the search sessions ends with the particular one of the users conducting the search session clicking on one of the network resources.

15. The media recited in claim 13, wherein, for each of the sets of clicked network resources associated with the particular one of the search sessions:
each network resource from the set of network resources provides a particular amount of utility to the particular one of the users conducting the particular one of the search sessions;
a total amount of utility provided by the set of clicked network resources is approximately the sum of the particular amounts of utility of the individual clicked network resources in the set; and
the total amount of utility satisfies the information need of the particular of the users conducting the particular one of the search sessions.

16. The media recited in claim 13, wherein the classifier model is a logistic regression model.

17. The media recited in claim 16, wherein to determine the classifier model comprises apply the sets of clicked network resources and the successive subsets of clicked network resources to the logistic regression model to train the logistic regression model.

18. The media recited in claim 13, wherein the software is further operable when executed by the one or more computer systems to apply the set of features to a ranking model to train the ranking model via machine learning.
